(19) United States
(12) Patent Application Publication
(10) Pub. No.: US 2024/0184182 A1
(43) Pub. Date: Jun. 6, 2024

(54) OPTICAL DEVICE HAVING A MACH-ZEHNDER INTERFEROMETER WITH IMPROVED LINEARITY

(71) Applicant: HEWLETT PACKARD ENTERPRISE DEVELOPMENT LP, Spring, TX (US)

(72) Inventors: Stanley Cheung, Milpitas, CA (US); Yuan Yuan, Milpitas, CA (US); Yiwei Peng, Milpitas, CA (US); Zhuoran Fang, Santa Barbara, CA (US); Bassem Tossoun, Santa Barbara, CA (US); Geza Kurczveil, Santa Barbara, CA (US); Raymond G. Beausoleil, Milpitas, CA (US)

(21) Appl. No.: 18/062,040

(22) Filed: Dec. 6, 2022

(51) Int. Cl. G02F 1/225; G02F 1/21

(52) U.S. Cl. CPC G02F 1/2257; G02F 1/212

(57) ABSTRACT

An example optical device, such as a Mach-Zehnder interferometer (MZI) is presented. The MZI includes a plurality of optical waveguide arms. At least one of the plurality of optical waveguide arms comprises a control gate, an optical waveguide, and a floating gate positioned between the control gate and the optical waveguide and electrically isolated from the optical waveguide and the control gate. The control gate receives a control voltage. The application of the control voltage to the control gate causes charges to accumulate in the floating gate resulting in a non-volatile change in an operating wavelength of the MZI.

### STATEMENT OF GOVERNMENT RIGHTS

This invention was made with Government support under Agreement Number H98230-18-3-0001. The Government has certain rights in the invention.

### BACKGROUND

Optical devices such as Mach-Zehnder interferometers (MZIs) and microring resonators (MRRs) are widely used as basic building blocks for optical neural networks. An optical neural network may include several neural network cells (e.g., comprising one or more MZIs and/or MRRs) arranged in a matrix. The optical neural network often requires these cells to be tuned frequently during a training phase of the optical neural network. Such tuning entails setting weights (e.g., wavelengths) for respective MZIs and/or MRRs. The latency and power consumption involved during the tuning of the MZIs and/or MRRs may impact the performance of the optical neural network.

### BRIEF DESCRIPTION OF THE DRAWINGS

Various examples will be described below with references to the following figures.

FIG. 1A depicts a top view of an example Mach-Zehnder interferometer (MZI).

FIG. 1B depicts a cross-sectional view along a waveguide arm of the MZI of FIG. 1A.

FIGS. 2A, 2B, 2C, 2D, 2E, and 2F depict states of charge carriers in an example MZI depending on applied voltages.

FIG. 3 depicts a graphical representation showing a simulated optical response of an example MZI.

FIG. 4 depicts a graphical representation showing tracking of spectral minima for several applied voltages.

FIG. 5 depicts a graphical representation showing multiple set states for an example MZI.

FIG. 6 depicts a graphical representation showing capacitive and optical hysteresis for an example MZI.

FIG. 7 depicts a cross-sectional view of an example optical device.

FIG. 8 depicts a block diagram of an example electronic system.

It is emphasized that, in the drawings, various features are not drawn to scale. In fact, in the drawings, the dimensions of the various features have been arbitrarily increased or reduced for clarity of discussion.

### DETAILED DESCRIPTION

The following detailed description refers to the accompanying drawings. Wherever possible, the same reference numbers are used in the drawings and the following description to refer to the same or similar parts. It is to be expressly understood that the drawings are for the purpose of illustration and description only. While several examples are described in this document, modifications, adaptations, and other implementations are possible. Accordingly, the following detailed description does not limit disclosed examples. Instead, the proper scope of the disclosed examples may be defined by the appended claims.

Optical systems include optical devices that can generate, process, and/or carry optical signals from one point to another point. Artificial neural networks have proven remarkable capabilities in various tasks, including computer vision, speech recognition, machine translations, medical diagnoses, and gaming. A majority of the electrical artificial neural network hardware's energy consumption is caused by data movements in the synaptic interconnections, for example, data movements between memory devices and processors. Optical neural networks, also known as photonic neural networks, are expected to improve energy efficiency and throughput significantly compared with electrical artificial neural networks due to the capabilities of transmitting data at the speed of light without having a length-dependent impedance.

Neuromorphic computing has shown significantly superior performance compared with traditional central processing units (CPUs) for specific neural network tasks. Optical interference allows efficient vector-matrix multiplication at the speed of light, which is a potential carrier for high-speed optical neuromorphic computing. In particular, the neuromorphic computing implemented via optical neural networks allows reduced or no optical-to-electrical conversion between photonic integrated circuits and external memory, thus lowering latency and power consumption.

As a quite common optical interference unit, an MZI is commonly used as a basic building block in optical neural networks. Also, the use of microring resonators (MRR) is common in optical neural networks. Accordingly, optical neural networks may include several neural network cells (e.g., comprising one or more MZIs, MRRs, or combinations thereof) arranged in a Matrix.

An optical neural network may be first trained using training datasets, and then such a trained optical neural network is implemented to generate inferences corresponding to real-time data. During the training procedure of an optical neural network, optical devices such as the MZIs and MRRs are often tuned several times (e.g., several hundreds of times). This tuning entails encoding the output of the MZI by way of causing a volatile or non-volatile change in the respective resonant wavelengths. To cause a change in the resonant wavelength, some implementations of the optical device entail the use of heaters causing a volatile change in the resonant wavelength, however, the heaters consume high power to maintain the change in the resonant wavelength. Some implementations entail the use of Micro-Electro-Mechanical Systems (MEMS) actuators to cause a volatile change in the resonant wavelength. While the MEMS actuators consume reduced power compared to heaters, the MEMS actuators are slow.

To achieve a non-volatile change in the resonant wavelength, some implementations entail the use of phase change materials (e.g., Antimony triselenide—Sb₂Se₃). The phase-change materials provide an attractive solution to energy-efficient photonic switches with zero static power, but the programming energy density remains high (e.g., on the order of hundreds of attojoule per cubic nanometer). Furthermore, some solutions entail the use of ferroelectric material such as Barium titanate (BaTiO₃) to cause the non-volatile change in the resonant wavelength. However, the use of the ferroelectric material requires hundreds of pulses to switch states and requires large footprints as phase shifters.

Recent literature also suggests integrating a memristor in an optical device (e.g., MRR) structure to cause a non-volatile change in the resonant wavelength. The use of a memristor on the optical structure requires a substrate with high background doping (e.g., of the order of 5×10¹⁷ cm⁻³) to cause an instant high electric field across the optical device. This high electric field causes a permanent change in the molecular structure of an oxide layer in the optical device leading to a non-volatile change in the resonant wavelength of the optical device. However, the operation of the optical device with such memristor behavior consumes more power, especially, to induce such a high electric field. Therefore, frequent setting and resetting of such optical devices with the memristor behavior may not be very energy efficient.

In accordance with the examples presented herein, an optical device is presented that may be implemented as an optical non-volatile memory unit while being energy efficient with enhanced bit-precision. In one example, a proposed MZI includes a plurality of optical waveguide arms. One or both of the plurality of optical waveguide arms includes a control gate to receive a control voltage, an optical waveguide to allow propagation of light there-through, and a floating gate sandwiched between the optical waveguide and the control gate. The floating gate is electrically isolated from the optical waveguide and the control gate, and the application of the control voltage to the control gate causes charge carriers to accumulate inside the floating gate resulting in a non-volatile change in an operating wavelength of the MZI. In some examples, permanent wavelength shifts of greater than 1 nm (equivalent to a frequency shift of greater than 175 GHz) were achieved as well as a complete reversal of this shift at several hundred picowatts (pWs) of dynamic power and zero or near zero (0) static power. The optical device of the present disclosure may be constructed of various oxides sandwiched between the control gate and the optical waveguide made of semiconductor materials.

The proposed optical device (e.g., the proposed MZI) has enhanced setting and resetting optical functionality reliably while causing large wavelength shifts. Such enhanced setting and resetting optical functionality reliably and the large wavelength shifts provide great advantages for optical processing/computing, neuromorphic/brain-inspired photonic neural networks, telecommunications, and/or data communications. Further, using the proposed structure of the optical device various types of optical logic gates, latches, and flip-flops may be constructed to produce an optical arithmetic logic unit. Further, the proposed optical device allows the data to be stored at multiple set states possible with simple DC voltage biases of different levels. Also, the proposed optical device consumes negligible power consumption for setting and resetting (e.g., of the order of several hundred pWs of dynamic power and near zero (0) pWs of static power).

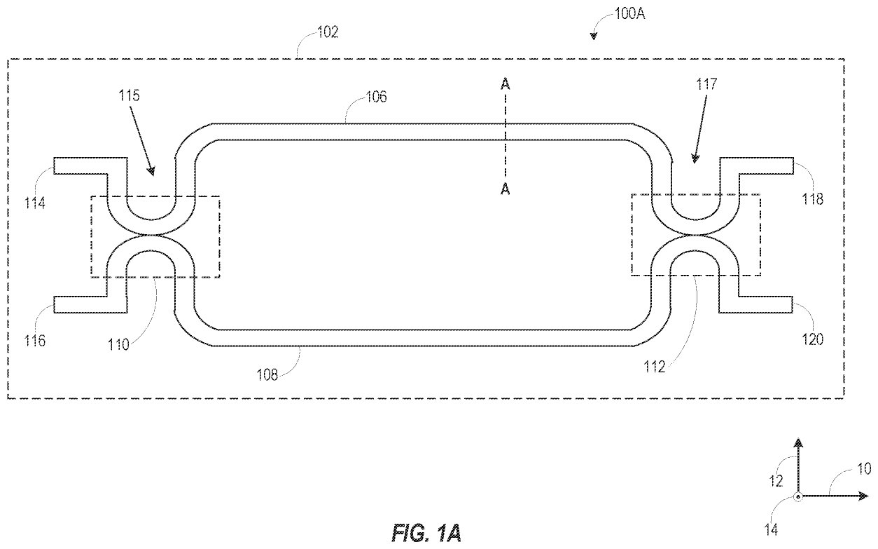

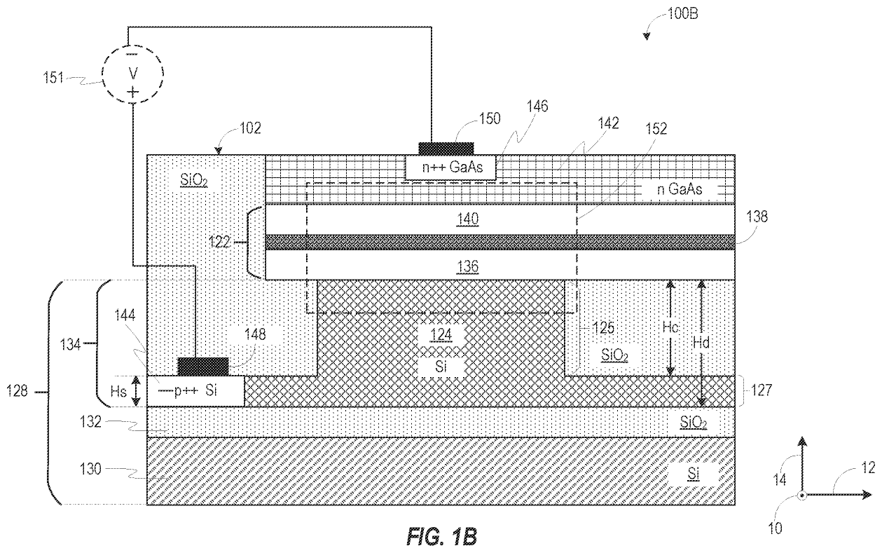

Referring now to the drawings, FIG. 1A depicts a top view 100A of an example MZI 102. Further, FIG. 1B depicts a cross-sectional view 100B taken along one of the optical waveguide arms of the MZI 102 of FIG. 1A. For the purpose of illustration hereinafter FIGS. 1A and 1B are referenced concurrently.

Arrows 10, 12, and 14, in FIGS. 1A-1B, represent an axial direction, a lateral direction, and a vertical direction (hereinafter referred to as “axial direction 10,” “lateral direction 12,” and “vertical direction 14”). The axial direction 10, the lateral direction 12, and the vertical direction 14 may be perpendicular to each other. Measurements along the axial direction 10, the lateral direction 12, and the vertical direction are hereinafter referred to as length, width, and height (or thickness), respectively.

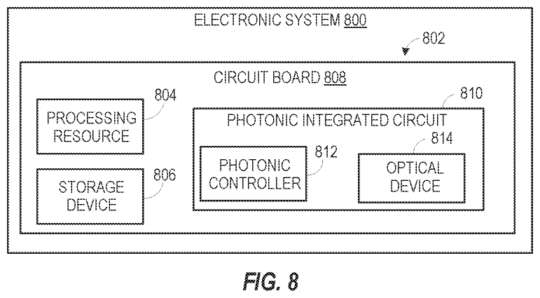

The proposed example MZI 102 may find applications in optical neural network systems capable of storing and processing data in optical form, or in any optical communication system. One or more such MZIs may be implemented in the form of a photonic integrated circuit (see FIG. 8). The photonic integrated circuit may be implemented in computers (stationary or portable), servers, storage systems, wireless access points, network switches, routers, docking stations, printers, or scanners.

The MZI 102 may include a plurality of optical waveguide arms, for example, a first optical waveguide arm 106 and a second optical waveguide arm 108; and a pair of optical couplers 110 and 112. In particular, the first optical waveguide arm 106 and a second optical waveguide arm 108 are connected to each other at a first end 115 via the optical coupler 110, and at a second end 117 via the optical coupler 112, as depicted in FIG. 1A. The optical couplers 110 and 112 may be operated as input coupler and output coupler, respectively. Accordingly, the optical couplers 110 and 112 are hereinafter also referred to as an input coupler 110 and an output coupler 112, respectively. Each of the optical waveguide arms 106, 108 and the optical couplers 110, 112 have a waveguide to allow propagation of the optical signals (e.g., light) therethrough during the operation of the MZI 102.

The input coupler 110 may have optical input ports 114 and 116, and the output coupler 112 may have output ports 118 and 120. An optical signal may be supplied to any of the input ports 114 and 116, and an optical output of the MZI 102 may be obtained from any of the output ports 118 and 120. For the purpose of illustration hereinafter, an optical signal may be considered as applied to the input port 114 and the optical output of the MZI 102 may be measured at the output port 118. In some examples, the MZI 102 is designed such that there may exist a phase difference of π between the optical signals appearing at the output ports 118 and 120.

During the operation of the MZI 102, an optical signal may be applied to the input port 114 of the MZI 102. The input optical signal may be divided into two light streams via the input coupler 110 and distributed into the two waveguide arms 106 and 108. The optical signals from both the optical waveguide arms 106 and 108 of the MZI 102 may be recombined and again divided into two optical output streams and exit via output ports 118 and 120. By changing the phase difference in the optical signals propagating in the two waveguide arms, the transmission intensity of and/or the phases of the optical output at the output ports 118 and 120 may be varied.

In accordance with the examples presented herein, the MZI 102 may allow a non-volatile change in its operating wavelength and may therefore be capable of being used as a non-volatile optical memory unit. The operating wavelength of the MZI 102 may refer to a wavelength of an optical output of the MZI 102 obtained at any of the output ports 118 and 120. For the purpose of illustration hereinafter, an optical output of the MZI 102 is measured at the output port 118. In order to cause the non-volatile change in the operating wavelength, the MZI 102 may include a floating gate structure 122 formed over an optical waveguide 124 (see FIG. 1B) in one or both of the optical waveguide arms 106, 108. As will be described in greater detail later, on the application of a control voltage to the MZI 102, the floating gate structure 122 may permanently store a certain amount of charge carriers in it causing a permanent change in the refractive index of the respective waveguide arm.

Referring now to FIG. 1B, the cross-sectional view 100B of a waveguide arm, for example, the first waveguide arm 106 is presented. In particular, the cross-sectional view 100B may be realized at position A-A on the first waveguide arm 106 shown in FIG. 1A. One or both the optical waveguide arms 106 and 108 are envisioned to have a similar cross-sectional structure as depicted in FIG. 1B.

As depicted in FIG. 1B, the MZI 102 includes the optical waveguide 124 formed in a semiconductor substrate 128. In some examples, the semiconductor substrate 128 may be a silicon-on-insulator (SOI) substrate that may include a base substrate layer 130, a base oxide layer 132, and a device layer 134. Further, the floating gate structure 122 is formed over the optical waveguide 124. The base substrate layer 130 may be made of semiconductor material, for example, silicon (Si). Other examples of materials that may be used to form the base substrate layer 130 may include Ill-V semiconductors, such as indium phosphide (InP), germanium (Ge), gallium arsenide (GaAs), aluminum gallium arsenide (AlGaAs), indium gallium arsenide (InGaAs), indium arsenide (InAs), or combinations thereof.

The base oxide layer 132 may be formed by oxidizing the base substrate layer 130 or by way of depositing a dielectric material over the substrate layer 130. In the implementation of the MZI 102, for the base substrate layer 130 made of silicon, the base oxide layer 132 may comprise silicon dioxide (SiO₂), which may be formed in the presence of oxygen at a temperature in the range from 900° C. to 1380° C. In some examples, the base oxide layer 132 may be a buried oxide (BOX) layer (e.g., the SiO₂ may be buried in the base substrate layer 130). Example materials of the base oxide layer 132 may include dielectric materials such as, but are not limited to, SiO₂, Silicon Nitride (Si₃N₄), Aluminum oxide (Al₂O₃), Hafnium Dioxide (HfO₂), diamond, silicon carbide (SiC), or combinations thereof. In some examples, a layer of SiO₂ may be buried in the base substrate layer 130.

The device layer 134 may be formed on top of the base oxide layer 132. In the example implementation of FIG. 1B, the device layer 134 is composed of silicon. Accordingly, the optical waveguide 124 is made of semiconductor material of the device layer (e.g., InP, Ge, GaAs, AlGaAs, InGaAs, InAs, or combinations thereof). In some examples, the device layer 134 may contain a background doping (e.g., p-type) of smaller than 1×10¹⁵ cm⁻³. In certain examples, the device layer 134 may be undoped or compensation doped to achieve net zero doping. In some examples, the device layer 134 may be compensation doped to achieve net p-type doping or n-type doping of fewer than 1×10¹⁵ cm⁻³.

The device layer 134 may be shaped (e.g., via techniques such as photolithography and etching) to form one or more regions, such as the optical waveguide 124 and contact regions (described later), for example. In an example, the device layer 134 may be shaped to form the optical waveguide 124 having a core region 125 and a base region (also referred to as a slab) 127. In one example, the core region 125 may be designed to have a height Hc (also referred to as a core height) of 300 nanometers (nm), and the base region 127 may be designed to have a height Hs (also referred to as a slab height) of 170 nm. Accordingly, the total height Hd (i.e., Hc+Hs) of the device layer may be 470 nm.

The floating gate structure 122 may include a first insulating layer 136, a floating gate 138, and a second insulating layer 140. In particular, the floating gate 138 may be electrically isolated from the optical waveguide 124 and a control gate 142 via the first insulating layer 136 and the second insulating layer 140. The first insulating layer 136 may be formed adjacent to and contacting the optical waveguide 124. Further, the floating gate 138 may be formed adjacent to and contacting the first insulating layer 136. The second insulating layer 140 may be formed adjacent to and contacting the floating gate 138. In particular, in some examples (see FIG. 1B), the first insulating layer 136, the floating gate 138, and the second insulating layer 140 may be stacked along the vertical direction 14. In some other examples, the first insulating layer 136, the floating gate 138, and the second insulating layer 140 may be stacked along the lateral direction 12.

In some examples, the first insulating layer 136, the floating gate 138, and the second insulating layer 140 may be formed of electrically insulating materials. In some other examples, the first insulating layer 136, the floating gate 138, and the second insulating layer 140 may include the same or different material or material combinations. By way of example, the first insulating layer 136, the floating gate 138, and the second insulating layer 140 may be made of Indium Tin Oxide (ITO), SiO₂, Si₃N₄, Al₂O₃, HfO₂, diamond, SiC, or combinations thereof. In the example implementation of FIG. 1B, the first insulating layer 136, the floating gate 138, and the second insulating layer 140 are shown as made of HfO₂, HfO₂, and Al₂O₃, respectively, for illustration purposes. During the operation, when a voltage is applied across metal contacts (described later), the first insulating layer 136 may act as a quantum tunneling layer allowing charge carriers to tunnel through the first insulating layer 136 and enter into the floating gate 138 when the applied voltage exceeds beyond a certain threshold. Further, the second insulating layer 140 may act as a charge-blocking layer that may restrict any movement of charge carriers between the floating gate and the control gate 142.

Further, the control gate 142 may be formed over the floating gate structure 122. In particular, the control gate 142 may be formed such that the floating gate structure 122 is positioned between the control gate 142 and the optical waveguide 124. In particular, the floating gate structure 122 and the control gate 142 are formed such that the first insulating layer 136 is positioned between the floating gate 138 and the optical waveguide 124, and the second insulating layer 140 is positioned between the control gate 142 and the floating gate 138. Also, in the example implementation of FIG. 1B, the optical waveguide 124, the floating gate structure 122, and the control gate are formed such that the control gate 142, the floating gate structure 122, and the optical waveguide 124 are vertically stacked (e.g., along the vertical direction 14). In some other examples, the optical waveguide 124, the floating gate structure 122, and the control gate are formed such that the control gate 142, the floating gate structure 122, and the optical waveguide 124 are laterally stacked (e.g., along the lateral direction 12).

The control gate 142 may be made of a semiconductor material such as Si, InP, Ge, GaAs, AlGaAs, InGaAs, InAs, or combinations thereof. For illustration purposes, the control gate 142 is shown as made of III-V semiconductor material (e.g., n-GaAs). In some examples, to form the control gate 142, a layer of a III-V semiconductor material may be heterogeneously formed contacting the floating gate structure 122, in particular, in contact with the second insulating layer 140. The control gate 142 may be formed using epitaxial growth, deposition techniques (e.g., CVD), wafer bonding, transfer printing, or combinations thereof. In particular, techniques such as epitaxial growth and/or wafer bonding of the control gate 142 facilitate planar heterogeneous integration of other device structures such as lasers, modulators, and photon detectors all on the semiconductor common substrate 128.

Further, in some examples, the MZI 102 may include contact regions 144 and 146 (hereinafter collectively referred to as contact regions 144-146). The contact region 144 is formed in the device layer 134 in electrical contact (e.g., in direct physical contact or via any intermediate electrically conductive material) with the optical waveguide 124. Accordingly, the contact region 144 may comprise the material of the device layer 134. Further, the contact region 146 is formed in the control gate 142 and includes a material of the control gate 142. In some examples, the contact regions 144 and 146 may respectively include a first-type doping (e.g., p-type doping) and a second-type doping (e.g., n-type doping). In some examples, for greater electrical conductivity, the contact regions 144 and 146 may have a higher concentration of respective doping in comparison to doping concentrations in the optical waveguide 124 and the control gate 142. Accordingly, the contact regions 144, 146 may be considered highly doped regions and are marked with labels “p++” and “n++” as depicted in FIG. 1B.

Moreover, in some examples, the MZI 102 may include metal contacts 148 and 150. As depicted in FIG. 1B, the metal contacts 148, 150 are formed in electrical contact (e.g., in direct physical contact or via any intermediate electrically conductive material) with the contact regions 144, 146, respectively. In some examples, the metal contacts 148, 150 may be formed on top of (i.e., vertically over) the contact regions 144, 146, respectively. Examples of materials used to form the metal contacts 148, 150 may include, but are not limited to, copper (Cu), gold (Au), Al, and/or platinum (Pt). In some examples, a power source 151 (which may be external to the MZI 102) may be connected to the metal contacts 148, 150 to apply a control voltage (V) to the MZI 102 to operate the MZI 102 as a non-volatile memory element. In particular, the power source 151 may be connected to the MZI 102 such that a positive potential is applied to the metal contact 148 and the negative potential is applied to the metal contact 150. In the description hereinafter, the control voltage (V) may also be referred to as an applied voltage or a voltage.

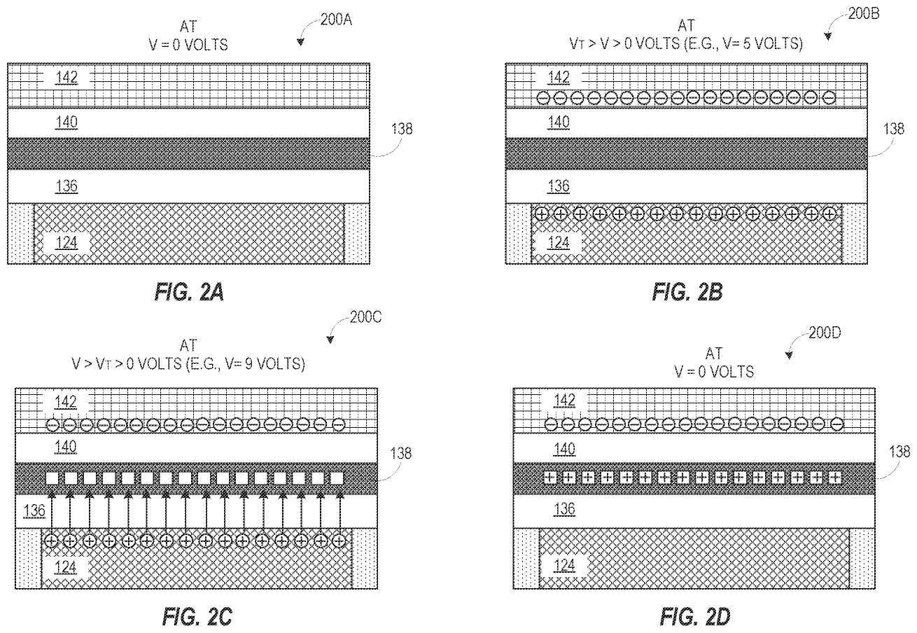

In accordance with examples consistent with this disclosure, the MZI 102 may be operated as a non-volatile memory element and may be implemented on neuromorphic computing applications, for example, optical neural networks. To operate the MZI 102 as an optical non-volatile memory unit, the control voltage may be applied across the metal contacts 148 and 150 via the power source 151 such that charge carriers (for example, positive charge carriers such as holes) may be permanently stored inside the floating gate 138. Such storage of the positive charge carriers inside the floating gate 138 may cause the floating gate 138 to remain positively charged even after the applied voltage is removed. In particular, due to the accumulation of the positive charge carriers inside the floating gate 138 may permanently attract opposite charge carriers (e.g., electrons) inside the control gate 142. As a result, the densities of electrons and holes, respectively, in the control gate 142 and the floating gate 138 may remain at a non-zero value even after the applied voltage is removed. Such a change (i.e., increase) in the densities of electrons and holes in the control gate 142 and the floating gate 138 may cause the refractive index of the MZI 102 in the given region to vary (i.e., reduce in this case). As will be understood, the change in the refractive index changes a wavelength passing through the MZI 102. The refractive index remains unchanged so long as the densities of electrons and holes remain steady, resulting in a non-volatile change in the operating wavelength of the MZI 102. Additional details about the effect of varying the control voltage in an example MZI are described in conjunction with FIGS. 2A-2F.

Referring now to FIGS. 2A-2F, states 200A, 200B, 2000, 200D, 200E, and 200F of charge carriers are depicted for several values of a control voltage applied across the metal contacts 148 and 150 (e.g., the control voltage (V) via the power source 151). For ease of illustration, in FIGS. 2A-2F, only a portion of the cross-sectional view 100B of FIG. 1B is depicted in FIGS. 2A-2B. In particular, in FIGS. 2A-2F, example carriers are overlayed on a portion 152 of the cross-section view 100B of the MZI 102.

In particular, FIG. 2A represents the state 200A of charge carriers when no voltage is applied to the metal contacts 148 and 150 (i.e., when V=0 Volts). In particular, when no voltage is applied across the metal contacts 148 and 150, no charge carriers accumulate in the control gate 142 and the optical waveguide 124 near the boundary of the floating gate structure 122. A value of the refractive index of the optical waveguide arm when no charge carriers are accumulated in the control gate 142 and the optical waveguide 124 near the boundary of the floating gate structure 122, is hereinafter referred to as a first refractive index value.

When the control voltage (V) is applied to the MZI 102 (i.e., positive potential at metal contact 148 and negative potential at the metal contact 150), as depicted in FIG. 2B, positive charge carriers (e.g., holes) and negative charge carriers (e.g., electrons) start to accumulate in the optical waveguide 124 and the control gate 142 near the floating gate structure 122 in a capacitor-like manner, for example. The accumulation of the charge carriers near the floating gate structure 122 may cause the refractive index of the optical waveguide arm to change to a second refractive index value different from the first refractive index value. In particular, such state of the charge accumulation shown in FIG. 2B may be volatile, that is, the charge carriers may disappear if the applied voltage is removed (i.e., made to drop to zero volts) from this state. Accordingly, the optical waveguide arm may not hold the refractive index to the second refractive index value if the applied voltage is removed from this stage.

If the applied voltage (V) is increased to a value higher than the tunneling voltage (V_{T}) of the first insulating layer 136 (i.e., V>V_{T}), the positive charge carriers from the optical waveguide 124 may gain sufficient energy to tunnel through the first insulating layer 132 and enter into the floating gate 138. Such migrant charge carriers (i.e., the positive charge carriers that have entered into the floating gate 138 from the optical waveguide 124) may eventually be captured by charge traps in the floating gate 138 (see FIG. 2C). From this stage, even if the applied voltage (V) is reduced to zero, these trapped positive charge carriers may remain in the floating gate 138 and attract negative charge carriers in the control gate 142 (see FIG. 2D). Due to the presence of the trapped positive charge carriers in the floating gate 138, the negative charge carriers in the control gate 142 remain attracted and be accumulated near the boundary of the floating gate structure 122 as long as the positive charge carriers are retained inside the floating gate 138. Such an accumulation of the charge carriers may cause the refractive index of the MZI 102 in the given region to vary (i.e., reduce in this case) resulting in the optical waveguide arm achieving a third refractive index value that is different from the first refractive index value and the second refractive index value. As will be understood, the change in the refractive index caused due to such trapped charge carriers in the floating gate 138 changes the operating wavelength of the light passing through the MZI 102. The refractive index at this stage (i.e., the third refractive index value) may remain unchanged so long as the charge carriers remain accumulated as shown in FIG. 2D, resulting in a non-volatile change in the operating wavelength of the MZI 102.

In some examples, control voltage with reverse polarity (i.e., the negative potential at metal contact 148 and positive potential at the metal contact 150) may need to be applied across the metal contacts 148, 150 to bring the refractive index of the optical waveguide arm back to its original value (e.g., the first refractive index value). In particular, if the applied voltage is further reduced below zero, the trapped positive charge carriers may tunnel back into the optical waveguide 124 (see FIG. 2E), thus resulting in an electrically neutral state (see FIG. 2F) with no charge carriers accumulated about the floating gate structure 122. This disappearing of the charge carriers from the floating gate 138 and the control gate 142 may in turn cause the refractive index to switch back to its original value. In particular, the volatile and non-volatile charge states may be controlled by controlling the applied voltage to manipulate the refractive index.

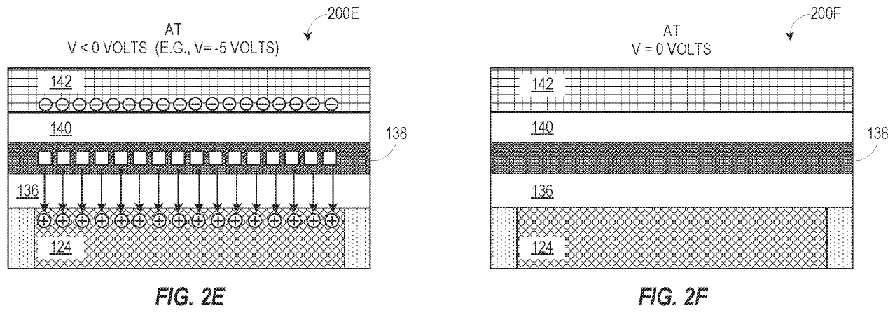

Turning now to FIG. 3, a graphical representation 300 showing a simulated optical response of an example MZI such as the MZI 102 is depicted. In particular, the simulated optical response of FIG. 3 may be realized at the output port 118 of the MZI 102. In the graphical representation 300, an X-axis 302 represents wavelength in micrometers (μm) and a Y-axis 304 represents optical power in decibels (dB). A curve 306 (represented with a solid line) represents an optical response of the example MZI 102 when no voltage is applied across the metal contacts 148 and 150. Further, a curve 308 (represented with a dashed line) represents an optical response of the example MZI 102 when a voltage having a magnitude greater than the tunneling voltage (V>V_{T}) is applied across the metal contacts 148 and 150. As can be seen in the graphical representation, the curve 308 is offset from the curve 306 by about 1 nm, indicating a non-volatile shift in the wavelengths.

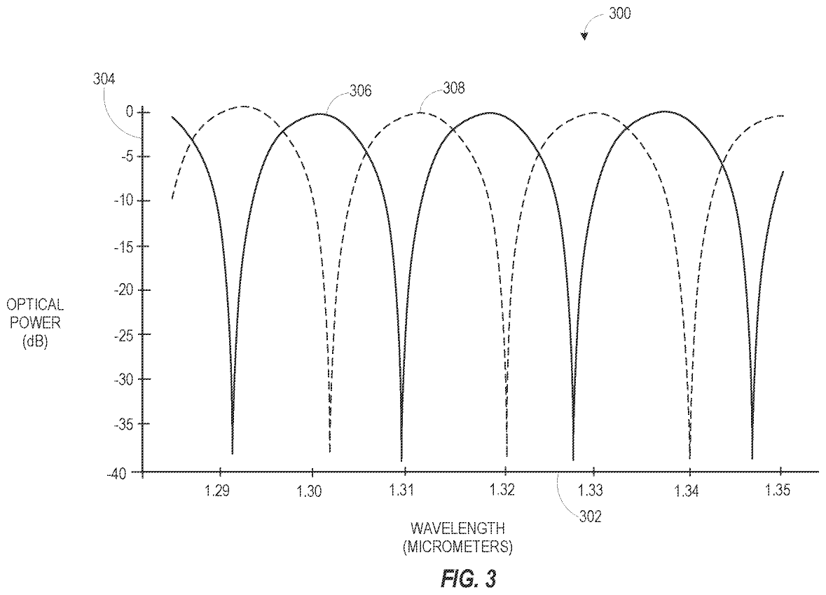

FIG. 4 depicts a graphical representation 400 showing tracking of wavelength shifts for an example MZI (e.g., the MZI 102) for several applied voltages for a single cycle of set-reset operation. In the graphical representation 400, an X-axis 402 represents bias points, and a Y-axis 404 represents wavelength in nanometer (nm). A bias point may refer to a sequential order of applying a new voltage. For example, at the bias points 1, 2, 3, 4, and 5, voltages of magnitudes 0V, 9V, 0V, −5V, and 0V, respectively, may be applied across the metal contacts 148, 150 of the MZI 102. For the purpose of simulation of the graphical representation 400, the MZI 102 may be designed to have the optical waveguide 124 having a width of 500 nm, the core height (Hc) of 300 nm, and a slab height (Hs) of 170 nm. Further, the height (Hb) of the base oxide layer 132 may be set to about 2 μm on the base substrate layer 130. Furthermore, the control gate 142 is made of 190 nm-thick n-GaAs with a doping concentration of 3×10¹⁸ cm⁻³. The floating gate 138 is made of a 5 nm-thick HfO₂ with a refractive index of n_{HfO2}=1.88. Optical confinements in the floating gate 138 (Γ_{HfO2}) and the control gate 142 (Γ_{III-V}) may be respectively at 1.159% and 28.33% with an overall effective index of n_{eff}=3.1154. Also, the total length of the MZI 102 is designed to be 350 μm.

With these design considerations, a single cycle of set and reset states is performed by ramping the applied voltage from zero volts to 9 volts (i.e., set operation) and then reducing the voltage to −5 volts and subsequently turning the voltage bias off (i.e., reset operation). As observed from the graphical representation 400, at the bias point 1 when the applied voltage (V) is zero volts, an operating wavelength of the MZI 102 may be about 1289.65 nm. Once the applied voltage is ramped up to 9V (at bias point 2) and then reduced to zero volts (at bias point 3), the operating wavelength of the MZI 102 may be set to about 1290.65 nm, which is 1 nm higher than the original operating wavelength (i.e., the operating wavelength at the bias point 1). Further, to reset the operating wavelength to the original value, −5 volts may be applied (at bias point 4) followed by reducing the voltage to zero volts again (at bias point 5). As can be seen in the graphical representation 400, with this reset operation, the operating wavelength of the MZI 102 may be restored to its original value of 1289.65 nm.

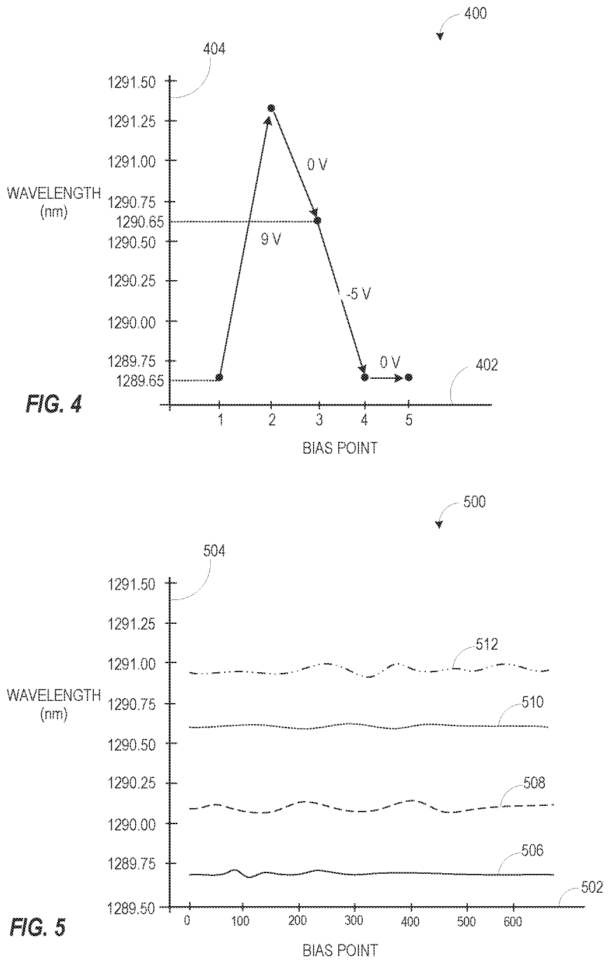

FIG. 5 depicts a graphical representation 500 showing multiple set states for an example MZI (e.g., the MZI 102 of FIGS. 1A-1B) for several non-volatile set values of the operating wavelength. In the graphical representation 500, an X-axis 502 represents bias points, and a Y-axis 504 represents wavelength in nanometer (nm). Further, for simulating the graphical representation 500, the MZI 102 is designed with similar design considerations as described in conjunction with FIG. 4.

A curve 506 (represented via a solid line) may represent an initial state (i.e., an original operating wavelength which may be about 1289.65 nm) corresponding to an applied voltage of zero volts. A curve 508 (represented via a dashed line) may represent a first write state corresponding to the applied voltage of 5V. The first write state may represent a first revised operating wavelength higher than the original operating wavelength. The MZI 102 may retain the first revised operating wavelength until a reset operation (i.e., applying −5V volts) is performed. Similarly, yet another write state may be obtained for another voltage magnitude higher than 5V. For example, a curve 510 (represented via a dotted line) may represent a second write state corresponding to the applied voltage of 9V. The second write state may represent a second revised operating wavelength higher than the first operating wavelength. The MZI 102 may retain the second revised operating wavelength until the reset operation is performed. Further, a curve 512 (represented via a dashed-dotted line) may represent a third write state corresponding to the applied voltage of 11 V. The third write state may represent a third revised operating wavelength higher than the second operating wavelength. The MZI 102 may retain the third revised operating wavelength until the reset operation is performed.

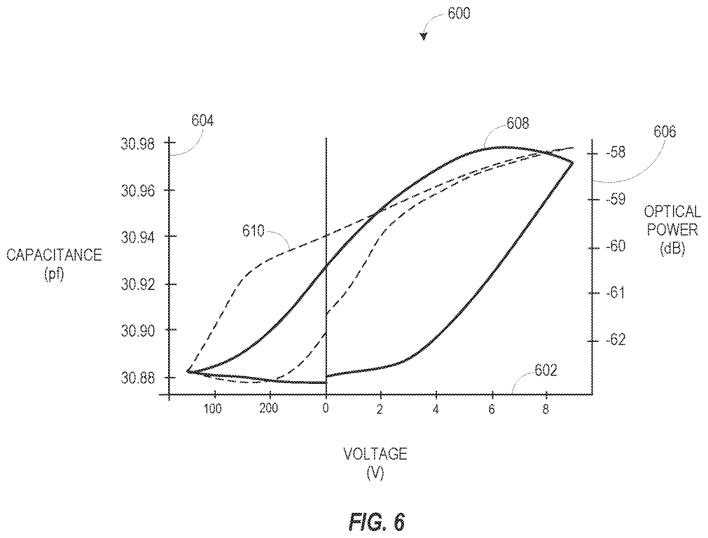

Referring now to FIG. 6, a graphical representation 600 showing a capacitive hysteresis and an optical hysteresis for an example MZI, such as, the MZI 102 is depicted. In the graphical representation 600, an X-axis 602 represents voltage values in volts (V), a first Y-axis 604 represents capacitance values in picofarad (pF), and a second Y-axis 606 represents an output optical power of the MZI 102 in decibels. For simulating the graphical representation 600, voltages of magnitudes 0V, 9V, 0V, −5V, and 0V, are applied across the metal contacts 148, 150 of the MZI 102 in an order as mentioned and values of capacitance and the optical output are determined. In the graphical representation 600, a hysteresis curve 608 represents the optical hysteresis depicting variations in the optical output with changes in the applied voltage. Further, a hysteresis curve 610 represents the capacitive hysteresis depicting variations in the capacitance of the MZI 102 between the control gate 142 and the optical waveguide 124 of the MZI 102. The capacitive hysteresis as depicted via the hysteresis curve 610 indicates charge trapping inside the floating gate 138 and confirms a reduced or no probability or possibilities of a memristor-like behavior. Typically, the memristor-like behavior may not cause hysteresis in a capacitance.

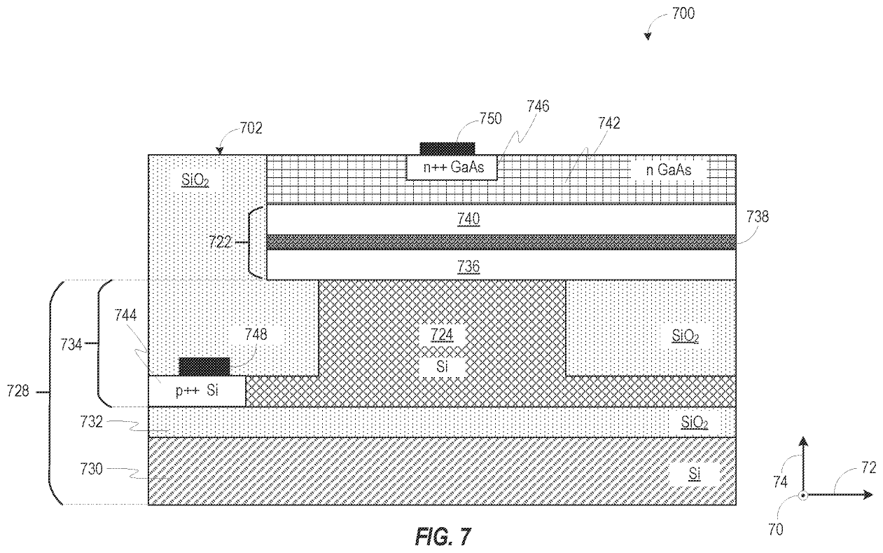

FIG. 7 depicts a cross-sectional view 700 of an example optical device 702. The optical device 702 of FIG. 7 may be an example representative of the MZI 102 of FIGS. 1A-1B and may include certain device structures similar to those already described in FIG. 1B. Further, in FIG. 7, arrows 70, 72, and 74 show an axial (or circumferential) direction, a lateral direction, and a vertical direction (hereinafter referred to as “axial direction 70,” “lateral direction 72,” and “vertical direction 74”). The axial direction 70, the lateral direction 72, and the vertical direction 74 may be perpendicular to each other.

The optical device 702 may be an example representative of any optical device such as a ring resonator (e.g., microring resonator (MRR)), an MZI (e.g., the MZI 102 of FIG. 1A-1B) optical converters, optical cables, waveguides, optical modulators (e.g., ring modulator), or optical demodulator (e.g., ring modulator). The optical device 702 may find applications in optical neural network systems capable of storing and processing data in optical form, or in any optical communication system. One or more such optical devices may be implemented in the form of a photonic integrated circuit (see FIG. 8). In one example, such a photonic integrated circuit may be implemented in computers (stationary or portable), servers, storage systems, wireless access points, network switches, routers, docking stations, printers, or scanners.

In some examples, the cross-sectional view 700 may be realized at one or more locations on the optical device 702. For example, if the optical device 702 is an MRR, the cross-sectional view 700 may be realized at one or more locations along a microring. In another example, if the optical device 702 is an MZI, such as the MZI 102, the cross-sectional view 700 may be realized along one or both optical waveguide arms of the optical device 702.

Further, in some examples, the cross-sectional view 700 may be similar to the cross-sectional view 100B depicted in FIG. 1B. For purpose of illustration, all the reference numerals that are depicted in FIG. 7 are increased by 700 in comparison to the reference numerals of the similar parts/regions/material layers depicted in FIG. 1B. For example, reference numeral 724 may represent an optical waveguide that is an example representative of the optical waveguide 124 described in FIG. 1B. It may be noted that the part/region/material layer shown in cross-sectional view 700 may have a different or similar topology, design, or layout than the top view 100A shown in FIG. 1A. For instance, if the optical device 702 is an MRR, a top view of such MRR may depict a ring or a ring-like structure. The ring-like structure may encompass a loop of any shape such as a circular loop, oval loop, rounded rectangle loop, rounded square loop, rounded triangle loop, etc., within the purview of the present disclosure. In some examples, an MRR having a loop shape that is elongated to have a straight section along one direction (e.g., racetrack-shaped or elongated oval-shaped) is also envisioned within the purview of the present disclosure.

Briefly, as depicted in FIG. 7, the optical device 702 may include the optical waveguide 724 formed in a semiconductor substrate 728. The semiconductor substrate 728 may include a base substrate layer 730, a base oxide layer 732, and a device layer 734. Further, a floating gate structure 722 formed over the optical waveguide 724 may include a first insulating layer 736, a floating gate 738, and a second insulating layer 740. Further, the optical device 702 may include a control gate 742 formed over the floating gate structure 722. Also, the optical device 702 may include contact regions 744 and 746, and metal contacts 748 and 746 formed in electrical contact with the contact regions 744 and 746, respectively.

In some examples, the control gate 742 may be made of a semiconductor material (e.g., a III-V semiconductor material) and receives a control voltage via the metal contact 750. Further, in some examples, the optical waveguide 724 may have a background doping concentration of smaller than 1×10¹⁵ cm⁻³. During the operation of the optical device 702, the optical waveguide 724 may allow propagation of light therethrough. Furthermore, the floating gate made 738 may be made of HfO₂ and positioned between the optical waveguide 724 and the control gate 742 and electrically isolated from the optical waveguide 724 and the control gate 742. In a similar fashion as described in conjunction with FIGS. 1A-1B through FIG. 6, the application of the control voltage to the control gate 742 causes charge carriers to accumulate inside the floating gate 138 resulting in a non-volatile change in the wavelength of the light propagating through the optical waveguide 724.

Referring now to FIG. 8, a block diagram of an example electronic system 800 is presented. Examples of the electronic system 800 may include but are not limited to, computers (stationary or portable), servers, storage systems, wireless access points, network switches, routers, docking stations, printers, or scanners. The electronic system 800 may be offered as a stand-alone product, a packaged solution, and can be utilized on a one-time full product/solution purchase or pay-per-use basis. The electronic system 800 may include one or more multi-chip modules, for example, a multi-chip module (MCM) 802 to process and/or store data. In some examples, the MCM 802 may include a processing resource 804 and a storage medium 806 mounted on a circuit board 808. Additionally or alternatively to the processing resource 804 and a storage medium 806, the MCM 802 may host a photonic integrated circuit 810 on the circuit board 808. In some other examples, one or more of the processing resource 804, the storage medium 806, and the photonic integrated circuit 810 may be hosted on separate MCM (not shown). The circuit board 808 may be a printed circuit board (PCB) that includes several electrically conductive traces (not shown) to interconnect the processing resource 804, the storage medium 806, and the photonic integrated circuit 810 with each other and/or with other components disposed on or outside of the PCB.

The processing resource 804 may be a physical device, for example, one or more central processing units (CPUs), one or more semiconductor-based microprocessors, microcontrollers, one or more graphics processing units (GPUs), application-specific integrated circuits (ASICs), a field-programmable gate arrays (FPGAs), other hardware devices, or combinations thereof, capable of retrieving and executing the instructions stored in the storage medium 806. The processing resource 804 may fetch, decode, and execute the instructions stored in the storage medium 806. As an alternative or in addition to executing the instructions, the processing resource 804 may include at least one integrated circuit (IC), control logic, electronic circuits, or combinations thereof that include a number of electronic components. The storage medium 806 may be any electronic, magnetic, optical, or any other physical storage device that contains or stores instructions that are readable and executable by the processing resource 804. Thus, the storage medium 806 may be, for example, Random Access Memory (RAM), non-volatile RAM (NVRAM), an Electrically Erasable Programmable Read-Only Memory (EEPROM), a storage device, an optical disc, and the like. In some embodiments, the storage medium 806 may be a non-transitory storage medium, where the term “non-transitory” does not encompass transitory propagating signals.

Further, in some examples, the photonic integrated circuit 810 may include a photonics controller 812 and one or more photonic devices such as the optical device 814. The optical device 814 may be an example representative of any of the MZI 102 of FIGS. 1A-1B or the optical device 702 of FIG. 7. The use of a different number of optical devices or the use of several different types of optical devices in the photonic integrated circuit 810 is also envisioned within the scope of the present disclosure. For example, the photonic integrated circuit 810 may also include other photonic devices such as but not limited to, optical converters, optical cables, waveguides, optical modulators (e.g., ring modulator), optical demodulators (e.g., ring demodulator), resonators, light sources (e.g., lasers), or the like. The photonic integrated circuit 810 may function as a neuromorphic computing unit capable of storing and/or processing data optically. Further, in some examples, the photonic integrated circuit 810 may include several of the optical device 814 arranged to form an optical neural network. The photonics controller 812 may be implemented using an IC chip such as, but not limited to, an ASIC, an FPGA chip, a processor chip (e.g., CPU and/or GPU), a microcontroller, or a special-purpose processor. During the operation of the electronic system 800, the photonics controller 812 may apply signals (e.g., voltages to adjust phase angle changes via phase shifter(s)) to operate the optical device 814.

As will be appreciated, the proposed MZI 102 and/or the optical device 702 may cause a permanent wavelength shift (e.g., about 1 nm which is equivalent to a frequency shift of greater than 175 GHz) as well as capable of a reversal to an original value. Such an enhanced setting and resetting optical functionality reliably and the large wavelength shifts provide great advantages for optical processing/computing, neuromorphic/brain-inspired photonic neural networks, telecommunications, and/or data communications. Further, using the proposed structure of the optical devices (102, 702), various types of optical logic gates, latches, and flip-flops may be constructed to produce an optical arithmetic logic unit.

Additionally, the proposed optical devices 102 and 702, are observed to draw currents below tens of pico-Amps (which is equivalent to about just a few hundred picowatts (pWs) of power) during the set and reset process. Also, once the set or reset operations are completed, the proposed optical device may consume zero or near zero (0) static power due to the capacitive structure formed via the control gate, floating gate structure, and the optical waveguide.

Furthermore, the proposed optical devices allow the data to be stored at multiple set states possible with simple DC voltage biases of different levels (see FIG. 5). Additionally, the set and reset of the optical wavelength may be achieved by simple DC bias control without any current compliance. Also, the shifts in the wavelengths are insensitive to the length of bias time (compared to the memristor-like operations). Further, the proposed optical devices are found robust and reliable device operations with at least hundreds of nonvolatile switching operations. Additionally, the proposed optical devices do not require any thermal tuning to cause wavelength shifts, thereby further reducing power consumption.

The terminology used herein is for the purpose of describing particular examples and is not intended to be limiting. As used herein, the singular forms “a,” “an,” and “the” are intended to include the plural forms as well, unless the context clearly indicates otherwise. The term “another,” as used herein, is defined as at least a second or more. The term “coupled to” as used herein, is defined as connected, whether directly without any intervening elements or indirectly with at least one intervening element, unless indicated otherwise. For example, two elements may be coupled to each other mechanically, electrically, optically, or communicatively linked through a communication channel, pathway, network, or system. Further, the term “and/or” as used herein refers to and encompasses any and all possible combinations of the associated listed items. It will also be understood that, although the terms first, second, third, fourth, etc. may be used herein to describe various elements, these elements should not be limited by these terms, as these terms are only used to distinguish one element from another unless stated otherwise or the context indicates otherwise. As used herein, the term “includes” means includes but not limited to, the term “including” means including but not limited to. The term “based on” means based at least in part on.

While certain implementations have been shown and described above, various changes in form and details may be made. For example, some features and/or functions that have been described in relation to one implementation and/or process may be related to other implementations. In other words, processes, features, components, and/or properties described in relation to one implementation may be useful in other implementations. Furthermore, it should be appreciated that the systems and methods described herein may include various combinations and/or sub-combinations of the components and/or features of the different implementations described. Moreover, method blocks described in various methods may be performed in series, parallel, or a combination thereof. Further, the method blocks may as well be performed in a different order than depicted in flow diagrams.

Further, in the foregoing description, numerous details are set forth to provide an understanding of the subject matter disclosed herein. However, an implementation may be practiced without some or all of these details. Other implementations may include modifications, combinations, and variations from the details discussed above. It is intended that the following claims cover such modifications and variations.

What is claimed is:

1. A Mach-Zehnder interferometer (MZI), comprising:
a plurality of optical waveguide arms, wherein at least one of the plurality of optical waveguide arms comprises:
a control gate to receive a control voltage;
an optical waveguide to allow propagation of light therethrough; and
a floating gate positioned between the optical waveguide and the control gate and electrically isolated from the optical waveguide and the control gate, and wherein application of the control voltage to the control gate causes charges to accumulate inside the floating gate resulting in a non-volatile change in an operating wavelength of the MZI.

2. The MZI of claim 1, wherein the plurality of optical waveguide arms comprises a first optical waveguide arm and a second optical waveguide arm coupled to each other via a pair of optical couplers.

3. The MZI of claim 2, wherein at least one of the first optical waveguide arm and the second optical waveguide arm comprise the control gate, the optical waveguide, and the floating gate.

4. The MZI of claim 1, wherein the control gate, the floating gate, and the optical waveguide are vertically stacked.

5. The MZI of claim 1, wherein the control gate, the floating gate, and the optical waveguide are laterally stacked.

6. The MZI of claim 1, wherein the floating gate is made of one or more of Hafnium Dioxide (HfO₂), Indium Tin Oxide (ITO), Silicon dioxide (SiO₂), Silicon nitride (Si₃N₄), Aluminum oxide (Al₂O₃), diamond, or Silicon Carbide (SiC).

7. The MZI of claim 1, wherein the control gate is made of a semiconductor material.

8. The MZI of claim 7, wherein the semiconductor material comprises Silicon (Si), one or more III-V materials, or combinations thereof.

9. The MZI of claim 1, wherein at least one of the plurality of optical waveguide arms further comprises:
a first insulating layer between the control gate and the floating gate; and
a second insulating layer the floating gate and the optical waveguide.

10. The MZI of claim 9, wherein the first insulating layer and the second insulating layer are made of one or more of HfO₂, ITO, SiO₂, Si₃N₄, Al₂O₃, diamond, or SiC.

11. The MZI of claim 1, wherein the optical waveguide is un-doped or comprises a background doping of smaller than 1×10¹⁵ cm⁻³ resulting in reduced power consumption.

12. The MZI of claim 1, wherein the application of the control voltage of 9 volts causes a non-volatile shift in the operating wavelength by about 1 nm.

13. An optical device, comprising:
a control gate made of a first semiconductor material to receive a control voltage;
an optical waveguide made of a second semiconductor material to allow propagation of light therethrough and comprises a background doping of smaller than 1×10¹⁵ cm⁻³; and
a floating gate made of HfO₂ and positioned between the optical waveguide and the control gate and electrically isolated from the optical waveguide and the control gate, and wherein application of the control voltage to the control gate causes charges to accumulate inside the floating gate resulting in a non-volatile change in a wavelength of the light propagating through the optical waveguide.

14. The optical device of claim 13, wherein the first semiconductor material is the same as the second semiconductor material.

15. The optical device of claim 13, wherein the first semiconductor material comprises one or more III-V semiconductor materials.

16. The optical device of claim 13, wherein the second semiconductor material is Si.

17. The optical device of claim 13, further comprising:
a first insulating layer between the control gate and the floating gate; and
a second insulating layer the floating gate and the optical waveguide.

18. The optical device of claim 17, wherein the first insulating layer is made of Al₂O₃, and the second insulating layer is made of SiO₂.

19. An electronic system, comprising:
a circuit board; and
a photonic integrated circuit mounted on the circuit board, wherein the photonic integrated circuit comprises an MZI, the MZI comprising:
a plurality of optical waveguide arms, wherein at least one of the plurality of optical waveguide arms comprises:
a control gate to receive a control voltage;
an optical waveguide to allow propagation of light therethrough; and
a floating gate positioned between the optical waveguide and the control gate and electrically isolated from the optical waveguide and the control gate, and wherein application of the control voltage to the control gate causes charges to accumulate inside the floating gate resulting in a non-volatile change in an operating wavelength of the MZI.

20. The electronic system of claim 19, wherein an optical waveguide comprises a background doping smaller than 1×10¹⁵ cm⁻³.
